(19) United States
(12) Patent Application Publication
(10) Pub. No.: US 2025/0317758 A1
(43) Pub. Date: Oct. 9, 2025

(54) Radio Resource Management Technique

(71) Applicant: Telefonaktiebolaget LM Ericsson (publ), Stockholm (SE)

(72) Inventors: Anders Furuskär, Stockholm (SE); Fedor Chernogorov, Espoo (FI); Niklas Andgart, Södra Sandby (SE); Joachim Sachs, Sollentuna (SE); Magnus Frodigh, Sollentuna (SE); Mikael Höök, Sollentuna (SE)

(21) Appl. No.: 18/865,813

(22) PCT Filed: May 19, 2022
(86) PCT No.: PCT/EP2022/063645

§ 371 Date: Nov. 14, 2024

(51) Int. Cl. H04W 24/02; G01S 7/00; G01S 13/86

(52) U.S. Cl. CPC H04W 24/02; G01S 7/006; G01S 13/86

(57) ABSTRACT

A technique for performing radio resource management is provided. As to a method aspect, a method performed by a radio node (100) for radio resource management, RRM, comprises a step of obtaining (202) environmental information for the radio node (100). The environmental information is indicative of a future state of one or more physical objects in an environment of the radio node (100). A propagation of radio waves in the environment depends on the one or more physical objects. The method further comprises a step of performing (206) or initiating to perform (206) the RRM. The RRM depends on the future state of the one or more physical objects in the environment of the radio node (100).

### TECHNICAL FIELD

The present disclosure relates to a technique for performing radio resource management. More specifically, and without limitation, methods and radio nodes for radio resource management are provided.

### BACKGROUND

Radio propagation depends on the environment of propagation such as location of physical objects which may act as blockers, reflectors, or diffractors. The physical objects may be stationary (e.g., buildings or hills) and some may be mobile such as vehicles. Optimal radio resource management (RRM) such as the allocation of radio resources depends on the radio propagation, and consequently, on the state (e.g., position) of the physical objects. Such dependency is typically quite complex.

The RRM is conventionally done in a reactive way (e.g., a reactive balancing of quality of service) based on measurements internal to the radio network. In other words the RRM will be modified in reaction to, for example, a reduction of the quality of service (Qos). This reactive RRM is not acceptable for some services, e.g. those of ultra-reliable low-latency communication (URLLC) type.

### SUMMARY

Accordingly, there is a need for an RRM technique which can improve Qos stability, for example fulfilling URLLC requirements.

As to a method aspect, a method performed by a radio node for radio resource management (RRM) is provided. The method comprises the step of obtaining environmental information for the radio node. The environmental information is indicative of a future state of one or more physical objects in an environment of the radio node. A propagation of radio waves in the environment depends on the one or more physical objects. The method further comprises the step of performing, or initiating to perform, the RRM. The RRM depends on the future state of the one or more physical objects in the environment of the radio node.

The state of the one or more physical objects may influence the propagation of the radio waves in the environment of the radio node. Therefore, the future state of the one or more physical objects may influence the future propagation of the radio waves in the environment of the radio node. For example, the one or more physical objects may comprise one or more obstacles or reflectors of the radio waves. The propagation of the radio waves may depend on the state of the one or more physical objects in that the radio waves are reflected (e.g., deflected) or absorbed (e.g., blocked) or diffracted or refract by the respective physical object, e.g. by at least one or each of the one or more physical objects.

The environmental information may comprise information (e.g., results of measurements) on the current state of the one or more physical objects, wherein the current state is indicative of the future state by virtue of at least one of physical laws of motion for the one or more physical objects and scheduling (e.g., controlling) motion of the one or more physical objects and/or by virtue of a machine learning entity (e.g., performing a machine learning algorithm). For example, the physical objects may comprise vehicles, and the scheduling of the motion may comprise controlling traffic lights and/or road signs including a variable message (i.e., variable-message signs). Alternatively or in addition, the physical objects may comprise robots or machine tools, and the scheduling of the motion may comprise computer-aided manufacturing.

Performing RRM may comprise beamforming, e.g. performing a beamformed reception or a beamformed transmission. The beamforming may use or avoid a direction between the radio node and one of the one or more physical objects. For example, the RRM may use a reflecting physical object or avoid a blocking physical object.

The propagation of radio waves in the environment from and/or to the radio node may depend on the state of the one or more physical objects. For example, a current propagation of radio waves or a future propagation of radio waves in the environment may depend on the current and future state, respectively, of the one or more physical objects. The future propagation of radio waves may correspond to a transmission or reception of a message at the radio node according to the RRM. The state may also be referred to as status. The propagation of radio waves may also be referred to as radio propagation.

The method may be performed by, and/or the radio node may be, a radio device, a network node, or a core node. The radio device may be radio connected or connectable to a radio access network (RAN). Alternatively or in addition, the network node may be a node (e.g., a base station, BS) of a or the RAN.

Alternatively or in addition, the core node may be a node of a core network (CN) serving the RAN.

The environmental information (e.g., according to the method aspect) may be indicative of a current state of the one or more physical objects in the environment of the radio node. The current state may be indicative of the future state.

The current state of the one or more physical objects (e.g., according to the method aspect) may be measured by one or more radio nodes. For example, the radio node performing the method according to the first method aspect may measure the current state of the one or more physical objects.

At least one or each of the one or more radio nodes measuring the current state and the radio node performing the method (e.g., according to the method aspect) may be a network node (NN) of a radio access network (RAN). The radio node may be a NN that is configured to provide radio access to one or more radio devices (RDs). The network node may serve a plurality of RDs.

The one or more physical objects may comprise at least one or all of the RDs served by the network node or the RAN. Alternatively or in addition, the current state of the one or more physical objects may be measured by one or more RDs served by the network node or the RAN.

Alternatively or in addition, the environment of the network node may be a coverage area of the network node or a coverage area of a transmission and reception point (TRP) associated with the network node or a distributed unit (DU) of the network node. For example, the environment of the network node may comprise a cell served by the network node, and optionally at least one or each (e.g., direct) neighboring cell of the served cell.

At least one or each of the one or more radio nodes measuring the current state and the radio node performing the method (e.g., according to the method aspect) may be a radio device wirelessly connected to a network node of a RAN. The environmental information of the radio device may be obtained on a downlink from the network node. Alternatively or in addition, the radio node performing the method (e.g., according to the method aspect) may be a radio device wirelessly connected to one or more other radio devices on a sidelink (SL). The one or more physical objects may comprise the one or more other radio devices. The current state of the one or more physical objects may be measured by one or more other radio devices wirelessly connected to the radio device. The environmental information may be obtained from one or more other radio devices wirelessly connected to the radio device.

The radio node may be a radio device (e.g., a user equipment, UE) that is configured for radio access to a radio access network (RAN) and/or for a sidelink (SL) to another radio device (e.g., another UE), e.g. when the radio device is out of coverage by a RAN. Performing RRM may comprise an autonomous resource selection, e.g., according to resource allocation mode 2 in the 3GPP document TR 37.985, clause 6.3.2.2, e.g. version 17.0.0.

Alternatively or in addition, the environment of the radio device may be a vicinity of the radio device or an area covered by a device-to-device communication (e.g., a proximity service or a sidelink or a discovery signal) of the radio device.

The radio node (e.g., according to the method aspect) may be a core node wirelessly connected to at least one network node of a RAN. The environmental information of the core node may be obtained from the at least one network node or from radio devices served by the at least one network node. The one or more physical objects may comprise one or more radio devices served by the core node. The current state of the one or more physical objects may be measured by one or more radio devices served by the core node.

The radio node may be a core node that is configured to support at least one of the RAN and the one or more radio devices, e.g., by providing a function of a core network (CN).

Alternatively or in addition, the environment of the core node may be a coverage area of a network node or a RAN supported by core node. For example, the environment of the core node may comprise a cell or a tracking area or a registration area served by the core node (e.g., a mobility management entity, MME, or an access and mobility management function, AMF).

Each of the radio device, the network node, and/or the core node may perform the method (e.g., in coexistence). For example, one or more radio devices may report measurements of the state to their serving network node or to their serving core node (e.g., including the database). For the method implemented at the network node or the core node, the obtaining step may comprise collecting the environmental information reported from one or more radio devices. For the method implemented at the network node or the core node, the step of initiating performing RRM may comprise sending the collected environmental information from the network node or the core node (e.g., the database) to the radio device or the network node. The latter step may correspond to the obtaining step of the method performed by the radio device or the network node.

The environmental information (e.g., according to the method aspect) may be external to at least one or each of a RAN of the radio node and a core network (CN) serving the radio node. Alternatively or in addition, at least one or each of the one or more physical objects may not comprise a radio device served by a RAN of the radio node or a CN of the radio node.

The obtaining (e.g., according to the method aspect) may comprise receiving reports from radio devices served by the radio node. The reports may be indicative of the environmental information. For example, the state of the one or more physical objects may be measured by at least one radio device (e.g., a narrowband and/or Industrial Internet of Things, IoT, device) and reported to the radio node (e.g., to the database) as its serving network node or core node (e.g., access and mobility management function, AMF).

Alternatively or in addition, the obtaining (e.g., according to the method aspect) may comprise retrieving the environmental information from a database (DB) used for scheduling or controlling the motion of the one or more physical objects.

Alternatively or in addition, the database may be a core node in the CN. The database may be shared between different radio nodes and/or core nodes and/or radio devices.

The current state and/or the future state of at least one or each of the one or more physical objects (e.g., according to the method aspect) may comprise at least one of a position, a velocity, a trajectory, a size, a shape, an orientation, a rotation, an electromagnetic reflectivity, and an electromagnetic absorption of the respective physical object in the environment of the radio node.

For at least one or each of the one or more physical objects, the state may comprise a combination of position and velocity and/or a combination of orientation and rotation. For example, the state of at least one or each of the one or more physical objects may comprise a phase space state of the respective physical object.

The size may be a volume of the respective physical object.

The shape may be represented using a Delaunay triangulation or a Voronoi polygon of a (e.g. closed) surface of the respective physical object. Alternatively or in addition, the shape may include the surface of the respective physical object being concave or convex. Alternatively or in addition, the shape may include the surface of the respective physical object being topologically closed or compact connected. Alternatively or in addition, the shape may include the surface of the respective physical object being topologically of genus zero (e.g., sphere) or genus one or more (e.g., doughnut or any other holed torus).

The position and/or the velocity may be represented by a (e.g., two-dimensional or three-dimensional) vector. The rotation may be a rate of rotation (i.e., a rotational frequency) or an angular velocity of the respective physical object. The orientation and/or the rotation may be represented by an (e.g., two-dimensional or three-dimensional) axial vector.

The electromagnetic reflectivity and/or the electromagnetic absorption (e.g., an attenuation) may be specific for (or may depend on) a radio frequency of the radio waves or a radio frequency used by the radio node.

The method (e.g., according to the method aspect) may further comprise or initiate the step of predicting the future state of the environment of the radio node based on the obtained environmental information.

The RRM may depend on the predicted future state (which may eliminate or augment an indirect dependency on an obtained current state). For example, the RRM may explicitly depend on both the obtained current state and the predicted future state.

The environmental information may be indicative of the future state in that the future state is predictable based on (e.g., can be inferred from) a current state comprised in the environmental information. The state of the environment may comprise at least one state of the one or more physical objects within the environment. The future state of the environment may comprise at least one future state of the one or more physical objects.

The future state of at least one of the one or more physical objects may be directly computed based on the current state (e.g. including historical information of the state) of the at least one physical object and analytical methods (e.g., analytical mechanics), optionally based on a dynamical model of the environment.

Alternatively or in addition, the future state of the environment of the radio node may be predicted based on machine learning (ML). The future state of at least one of the one or more physical objects may be the result of ML used by the radio node.

The obtained environmental information (e.g., according to the method aspect) may include a schedule of a trajectory of the one or more physical objects. The future state may be predicted based on the schedule.

The one or more physical objects may comprise one or more public transportation vehicles (e.g., a bus, a tram, a trolley or a train). The prediction of the future state may be based on a traffic schedule (e.g., including a street route or railway path with stops and times as the trajectory). Alternatively or in addition, the schedule may be retrieved from a traffic control database.

The one or more physical objects (e.g., according to the method aspect) may include one or more automated guided vehicles (AGVs). The environmental information may be received from the one or more AGVs.

The predicting of the future state of the at least one or more physical objects (e.g., according to the method aspect) may comprise predicting at least one of a position, a velocity, a trajectory, a size, a shape, an orientation, a rotation, an electromagnetic reflectivity, and an electromagnetic absorption of the respective physical object in the environment of the radio node. The RRM may depend on the predicted future state of the at least one or each of the one or more physical objects.

Predicting the future state of the environment may comprise computing the state for a short term and/or using an approximation in first order of time. For example, the position and/or the orientation may be predicted for a time t1 based on the combination obtained for a time t0<t1 assuming a constant velocity and/or rotation, respectively (e.g., by multiplying the velocity and/or rotation, respectively, with the time difference time t1−t0 and adding the obtained velocity and/or rotation).

The velocity of any one of the one or more physical objects may be constant or changing. Alternatively or in addition, the state of any one of the one or more physical objects may be changing periodically (e.g., according to a harmonic motion).

Predicting the future state of the environment may comprise a probability related to the future state (or a set of alternative future states). The probability may be any number between 0 and 1 (e.g., 0 means the future state is not going to happen and 1 means the future state certainly will happen).

The RRM may depend on the future state in that one or more RRM requirements (e.g., one or more RRM parameters) of the RRM may guarantee initial access and/or mobility, e.g. for dual connectivity (DC, e.g., a DC between different radio access technologies, optionally LTE-NR DC), and/or for a Supplemental Uplink (SUP), and/or for Carrier Aggregation (CA, e.g., a CA within a radio access technology, optionally NR-NR CA).

Alternatively or in addition, a change of the one or more RRM parameters depending on the future state (i.e., an impact of the future state on the one or more RRM parameters) may be directly computed (e.g., estimated) and/or may result from a trained model (e.g. a neural network). For instance, the computation may comprise determining whether a line-of-sight between the radio node (e.g., the network node of the RAN such as a base station or a radio device such as a user equipment) and another radio node (e.g., a radio device served by the network node or another radio device in SL communication with the radio device) is blocked by one of the one or more physical objects (which may be referred to as a blocker).

A position of the other radio node may be reported from the other radio device to the radio node and/or may be determined using the RAN (e.g., by positioning of the other radio device using a 3GPP access network or a non-3GPP access network).

If the line-of-sight is not blocked, the RRM may comprise using a first set of transmission parameters (e.g., suitable for a good channel). For example, the RRM (e.g., the first set) may comprise a high or increased modulation and coding scheme (MCS), a high or increased order of a multiple-input multiple-output (MIMO) transmission, a low or reduced transmit power, and/or a beam directed in the line-of-sight direction. If line-of-sight is blocked, the RRM may comprise using a second set of transmission parameters (e.g., suitable for a worse channel). For example, a robust or more robust MCS, a high or increased transmit power, and/or a wide or wider beam (e.g., covering propagation paths around the blocker). Above relative statements (such as high or increased, etc.) may relate to the respective transmission parameter in the first and second set.

A more sophisticated example may be to combine the RRM (e.g., a state of the one or more RRM parameters) with a model of the environment (e.g., a rest of the propagation environment). The model of the environment may comprise a digital map of the environment. Based on this combination, the method may comprise computing an effect of the one or more RRM parameters on a channel state (e.g. a channel gain and/or signal quality). The computation may use a ray-tracing propagation model. In the ray-tracing propagation model, an effect of the one or more physical objects (e.g., a blocker or a reflector) may be represented by rays intersecting with the respective object being blocked or reflected.

The current state and/or the future state of the one or more physical objects in the environment of the radio node (e.g., according to the method aspect) may be the result of real-time simulations of the one or more physical objects. The real-time simulations of the one or more physical objects may be a digital twin (DT) of the one or more physical objects in the environment of the radio node.

The method may take the current and/or future state of the DT, or other external input, into account in the RRM (e.g., for beamforming). The DT may represent one or more physical objects external to the radio node, e.g. in the coverage area of the radio node. Herein, external may refer to one or more physical objects that are not (e.g., by wire or wirelessly) connected to the radio node and/or one or more physical objects other than radio devices (e.g., UEs) or network nodes (e.g., BSs).

Herein, the DT may be defined according to the Digital Twins Consortium. Alternatively or in addition, the DT may be a virtual representation (e.g., a numerical simulation) of real-world entities (e.g., the one or more physical objects) and processes (e.g., motions of the one or more physical objects). The entity or process represented by the DT may also be referred to as a projected entity or process.

The virtual representation may be synchronized (e.g., corrected based on measurements and/or the current state) at a specified frequency and/or fidelity. To build such a virtual representation, it may be necessary to acquire and/or maintain up-to-date the current state of the respective entity or process.

The technique may be applied to any specific environment type (e.g., type of radio network). The radio network may be a wide-area network, optionally deployed within a city, or a local and/or non-public network, such as a factory or campus network.

In any embodiment, the obtaining step may require actual information about the one or more physical objects (e.g., obstacles) which affect the radio propagation in the environment. The environmental information may include at least one of location, material, shape and size of the one or more physical objects. Alternatively or in addition, the environmental information may include an environment state. For example, the environmental information may be indicative of at least one of temperature and precipitation.

Location information (e.g., of the one or more physical objects and/or the other radio node) can be gathered by means of, but not limited to, Internet of Things (IoT, narrowband IoT) sensors with localization capabilities or leveraging positioning algorithms of the radio network itself, e.g. power measurements, time difference of arrival (OTDOA), uplink time difference of arrival (UL-TDOA), round trip time (RTT) and angle-based positioning, etc.

The current state and/or the environmental information may be provided by (i.e. made available by) and/or obtained at the radio node (and/or one or more other radio nodes), optionally using the DT. How the current state and/or the environmental information is obtained by the radio node (and/or the one or more other radio nodes) may be implemented in various degrees of distribution. In one example, the current state and/or the environmental information is collected by a single radio node and stored in a central database, from which other radio nodes in turn may collect the current state and/or the environmental information. Alternatively or in addition, the radio node performing the method and/or each of the radio nodes measuring the current state and/or the environmental information may communicate information sources for the current state and/or the environmental information, and/or may exchange information between each other in a peer-to-peer manner.

In a city environment, the DT may comprise a city transportation system. The DT may be indicative of positions and/or routes of cars, buses, trucks and/or trains (e.g., which can be used as input to the performed RRM). In a factory environment, automated guided vehicles (AGVs) or a control system for AGVs may provide the environmental information, e.g., information about locations and/or paths of the AGVs (e.g., within a factory hall).

The prediction of the future state of the environment (e.g., according to the method aspect) may be the result of the machine learning entity (e.g., performing a machine learning algorithm and/or comprising one or more neural networks). The machine learning entity may be trained using at least one of the obtained environmental information for the radio node; and the DT of the one or more physical objects in the environment of the radio node.

The machine learning entity (e.g., a neural network) may use supervised learning or unsupervised learning or reinforced learning. The future state of the environment may comprise the position and the velocity of the one or more physical objects. The machine learning entity may use the DT (e.g., as training data) for predicting the future state of the environment.

The training may be done in a dedicated training phase before the machine learning entity is used for the predicting, and/or while predicting (i.e., “on the fly” during normal operation). The training (e.g., updating) of the machine learning entity may be done periodically or may be triggered by a change in the environment and/or a change in the DT.

The radio node may obtain (e.g., collect) the environmental information (e.g., data that is relevant for calculation of a radio channel state, RCS) and may use it in the training phase.

The environmental information may be obtained (e.g., collecting), optionally for the training phase, through a drive tests. The radio node may control a controller of vehicles (e.g., AGVs and/or at least one of the one or more physical objects) performing the drive test. For example, the radio node may define routes (e.g., paths) of the vehicles performing the drive tests and/or of the one or more moving physical objects.

Predicting the future state may be used for the performing of RRM (e.g., for making the optimum decision for the RRM). For example, MCSs may be correlated with positions (e.g., locations) and properties of the one or more physical objects (e.g., one or more influencing objects) within the environment of the radio node. The radio node may further cross-validate the RRM performed according to the method aspect with a RRM performance or RRM decision based on channel state information (CSI) or any other information that is internal to at least one or each of the RAN of the radio node and the CN serving the radio node.

If the environment of the radio node is highly variable due to (e.g., motion) of the one or more physical objects and/or less influenced by other factors (e.g., a changing atmosphere or environmental state), performing the RRM based on the environmental information and/or building the DT based on the environmental information can be particularly beneficial.

Alternatively or in addition, if the environment of the radio node is highly dynamic (e.g., due to a traffic profile of the one or more physical objects), training the machine learning entity based on a sample of obtained environmental information (e.g., data) may be beneficial. The radio node may, for example, apply K-fold cross-validation (also known as leave-one-out method) to estimate or verify a responsiveness (also referred to as the skill) of the trained machine learning entity, e.g., to avoid averaging out of sporadic variations in the channel conditions.

The prediction of the future state of the environment of the radio node may be a result of a machine learning entity. The machine learning entity may be trained by the environmental information and/or the environmental information may be input to the trained machine learning entity.

The RRM (e.g., according to the method aspect) may be performed, or may be initiated to be performed, based on at least one of the obtained environmental information for the radio node, the environmental information being indicative of the future state of one or more physical objects in the environment of the radio node. For example, the RRM may be performed, or may be initiated to be performed, based on the DT of the one or more physical objects in the environment of the radio node, the DT comprising or being based on the obtained environmental information for the radio node. Alternatively or in addition, the RRM may be performed, or may be initiated to be performed, based on the predicted future state of the environment of the radio node.

The RRM (e.g., according to the method aspect) may be performed based on at least one RRM parameters. The at least one RRM parameter may comprise at least one of a channel gain computed based on the future state (e.g., of digital twins representing the one or more physical objects) and/or the environmental information; a signal gain computed based on the future state (e.g., of digital twins representing the one or more physical objects) and/or the environmental information; a signal to interference and noise ratio (SINR) computed based on the future state (e.g., of digital twins representing the one or more physical objects) and/or the environmental information; a modulation and coding scheme (MCS) computed based on the future state (e.g., of digital twins representing the one or more physical objects) and/or the environmental information; a link adaptation computed based on the future state (e.g., of digital twins representing the one or more physical objects) and/or the environmental information; and beamforming computed based on the future state (e.g., of digital twins representing the one or more physical objects) and/or the environmental information.

The performing of the RRM (e.g., according to the method aspect) may comprise at least one of controlling a power of a radio transmission from the radio node; steering a beam of a radio transmission from the radio node and/or a radio reception at the radio node; handing over a radio device to another serving cell (e.g., of the radio node or another radio node); allocating radio resources in a frequency domain and/or a time domain to a radio device (e.g., served by the radio node); and adapting a modulation and coding scheme (MCS) of a downlink from the radio node to a radio device and/or an uplink from a radio device to the radio node.

The predicting of the future state of the physical object (and/or the performing or initiating to perform an RRM) may further comprise maintaining, for each of the one or more physical objects, a or the DT of the respective physical object. Alternatively or in addition, the obtaining of the environmental information may comprise deriving the future state from the DT of the respective physical object.

The digital twin may comprise and/or may be referred to as a real-time numerical representation of at least one of the one or more physical objects. The numerical representation of a physical object may depend on a so-called digital thread, i.e. the lowest level (or physical level) dynamics and/or specification for the numerical representation. The numerical representation may depend on the digital thread to maintain accuracy.

The DT (e.g., according to the method aspect) may be maintained for a plurality of physical objects. Performing the RRM may comprise computing beamforming weights for a plurality of radio devices. For example, the plurality of radio devices may be located in a coverage area (e.g., a cell) of the radio node, and the DT is maintained for the plurality of physical objects located coverage area.

Alternatively or in addition, the DT (e.g., according to the method aspect) may be maintained for a plurality of physical objects. Performing the RRM may comprise selecting MCSs for a plurality of radio devices. For example, the plurality of radio devices may be located in a coverage area (e.g., a cell) of the radio node, and the DT is maintained for the plurality of physical objects located coverage area.

The selecting of MCSs may also be referred to as link adaptation.

As to a device aspect, a radio node for radio resource management (RRM) is provided. The radio node comprises memory operable to store instructions and processing circuitry operable to execute the instructions, such that the radio node is operable to obtain environmental information for the radio node. The environmental information is indicative of a future state of one or more physical objects in an environment of the radio node. A propagation of radio waves in the environment depends on the one or more physical objects. The processing circuitry is further operable to execute the instructions, such that the radio node is operable to perform or initiate performing the RRM. The RRM depends on the future state of the one or more physical objects in the environment of the radio node.

The processing circuitry of the radio node (e.g., according to the device aspect) may be further operable to perform any one of the steps of the method aspect.

As to a further device aspect, a radio node for radio resource management (RRM) is provided. The radio node is configured to obtain environmental information for the radio node. The environmental information is indicative of a future state of one or more physical objects in an environment of the radio node. A propagation of radio waves in the environment depends on the one or more physical objects. The radio node is further configured to perform or initiate performing the RRM.

The RRM depends on the future state of the one or more physical objects in the environment of the radio node.

The radio node (e.g., according to the device aspect) may further be configured to perform any one of the steps of the method aspect.

The radio node may be a network node (e.g., a base station). The network node may encompass any station that is configured to provide radio access to any of the radio devices. The network node may comprise, or may also be referred to as, a cell, a transmission and reception point (TRP), a radio access node, or an access point (AP). The radio node as the network node and/or the radio node as a relay radio device may provide a data link to a host computer. The host computer may provide user data to another radio node and/or may gathering user data from the other radio node. Examples for the network node (e.g., base station) may include a 3G base station or Node B (NB), 4G base station or eNodeB (eNB), a 5G base station or gNodeB (gNB), a Wi-Fi AP, and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR), or any further generation of mobile or wireless communications.

### BRIEF DESCRIPTION OF THE DRAWINGS

Further details of embodiments of the technique are described with reference to the enclosed drawings, wherein:

FIG. 1 shows a schematic block diagram of an embodiment of a device for radio resource management;

FIG. 2 shows a flowchart for a method of radio resource management, which method may be implementable by the device of FIG. 1;

FIG. 3 schematically illustrates a first example of a radio network comprising embodiments of the device of FIG. 1 performing the method of FIG. 2;

FIG. 4 schematically illustrates a second example of a radio network comprising embodiments of the device of FIG. 1 performing the method of FIG. 2;

FIG. 5 shows an example of the impact of a blocker on the channel gain;

FIG. 6 shows a schematic block diagram of a radio node embodying the device of FIG. 1;

FIG. 7 shows a schematic block diagram of a radio device embodying the device of FIG. 1;

FIG. 8 schematically illustrates an example telecommunication network connected via an intermediate network to a host computer;

FIG. 9 shows a generalized block diagram of a host computer communicating via a base station or radio device functioning as a gateway with a user equipment over a partially wireless connection; and

FIGS. 10 and 11 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

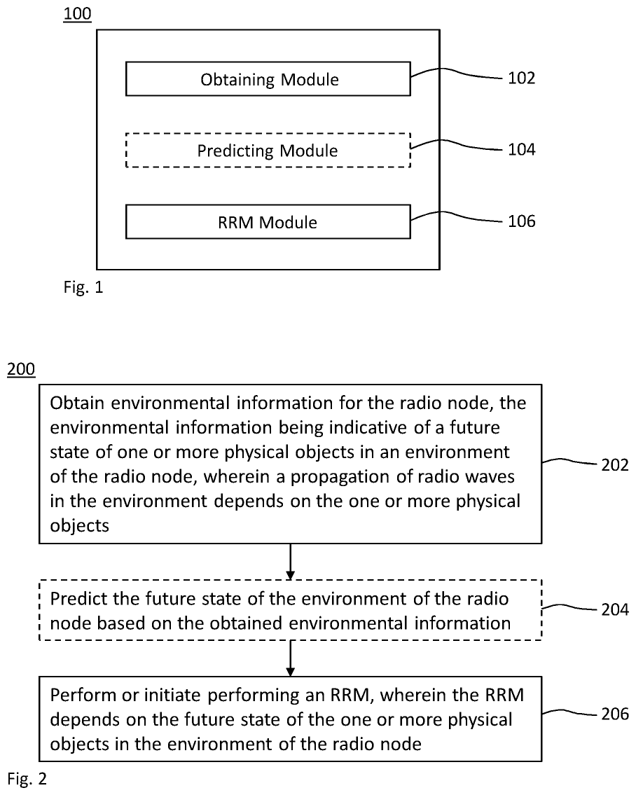

FIG. 1 schematically illustrates a block diagram of an embodiment of a device for radio resource management (RRM). The device is generically referred to by reference sign 100. The device 100 may also be referred to as, or may be embodied by, the radio node. The radio node may be a transmitting station (or briefly: transmitter) or a radio network node (or briefly: network node) serving a plurality of radio devices or a network node of a radio access network (RAN) or a network node serving a plurality of radio devices or a core node of a core network (CN). Alternatively or in addition, the radio node 100 may be a radio device (RD) served by a or the network node or served by the RAN.

The radio node 100 comprises an obtaining module 102 that may obtain environmental information for the radio node 100. The environmental information may comprise information of the physical environment of the radio node 100.

The environment of the radio node may be understood as the coverage area of the radio node 100. The physical environment (or briefly: environment) may comprise one or more physical objects. At least one or each of the one or more physical objects may be an object with a surface (e.g., floor, ceiling, and wall) and/or a volume (e.g., plant, machine, robot, mechanical equipment, etc.) within the environment (e.g., coverage area) of the radio node 100.

At least one or each of the one or more physical objects may be stationary or mobile relative to the radio node 100. The physical object may have different electromagnetic properties. Therefore, the electromagnetic wave propagation within the physical environment of the radio node 100 may be highly affected by characteristics (e.g., reflection, refraction, absorption, etc.) of the one or more physical objects and the state of the one or more physical objects.

The state of the one or more physical objects may be defined by dimensions (e.g., size) of the physical objects and the (e.g., relative) positions and/or velocities of the physical objects (e.g., relative to each other), and/or within the physical environment and/or with reference to the radio node 100. The (e.g., current) state and/or the future state of at least one or each of the one or more physical objects comprise at least one of a position, a velocity, a trajectory, a size, a shape, an orientation, a rotation, an electromagnetic reflectivity, and an electromagnetic absorption of the respective physical object in the environment of the radio node 100. The size may be a volume of the respective physical object.

The state of the physical object may change over time (e.g., may be a function of time, for example one or more physical objects moving, rotating, oscillating etc.). Hence the propagation of electromagnetic wave (e.g., radio wave) within the physical environment may change over time (e.g., may be a function of time).

The one or more physical objects may comprise one or more radio devices (RDs).

The state of the physical object may be indicative of a future state of the physical object.

The environmental information may be indicative of a current state of the one or more physical objects in the environment of the radio node 100. The current state may be indicative of the future state. The current state of the one or more physical objects may be measured by one or more radio nodes 100.

The environmental information may be external to at least one or each of a RAN of the radio node 100 and a core network (CN) serving the radio node 100. At least one or each of the one or more physical objects may not comprise a radio device served by a RAN of the radio node 100 or by a CN of the radio node 100.

The obtaining of the environmental information may comprise receiving reports from radio devices served by the radio node 100. The reports may be indicative of the environmental information. The obtained environmental information may be saved in a memory of the radio node 100 and/or in a shared memory device comprising memory shared between the radio nodes and/or a database (DB) and/or a cloud.

The obtaining environmental information may comprise retrieving the environmental information from a database (DB) used for scheduling or controlling the motion of the one or more physical objects.

The current state and/or the future state of at least one or each of the one or more physical objects may comprise at least one of a position, a velocity, a trajectory, a size, a shape, an orientation, a rotation, an electromagnetic reflectivity, and an electromagnetic absorption of the respective physical object in the environment of the radio node 100.

For at least one or each of the one or more physical objects, the state may comprise a combination of position and velocity and/or a combination of orientation and rotation. For example, the state of at least one or each of the one or more physical objects may comprise a phase space (e.g., vector composed of the position and velocity) state of the respective physical object.

The position and/or the velocity may be represented by a (e.g., two-dimensional or three-dimensional) vector. The rotation may be a rate of rotation (i.e., a rotational frequency) or an angular velocity of the respective physical object. The orientation and/or the rotation may be represented by an (e.g., two-dimensional or three-dimensional) axial vector.

The obtaining module 102 may obtain environmental information to build a virtual representation of the environment and/or a digital twin (DT) of the environment. The DT may be defined according to the Digital Twins Consortium and/or as “a virtual representation of real-world entities and processes, synchronized at a specified frequency and fidelity”. In other words a digital twin may be a digital simulation of a physical environment with real-time updates.

The digital twin may also be referred to as a real-time numerical representation of at least one physical object. The numerical representation of the physical object may depend on a so-called digital thread, i.e. the lowest level (or physical level) dynamics and/or specification for the numerical representation. The numerical representation may depend on the digital thread to maintain accuracy.

To build such a virtual representation (e.g., DT), it is necessary to acquire and maintain up to date the current state of the projected entity or a process. The proposed solution may be agnostic to a specific environment type (e.g., type of radio network). The radio network may be a wide-area network, optionally deployed within a city, or a local and/or non-public network, such as a factory or campus network. In any embodiment, the obtaining step may require actual information about the one or more physical objects (e.g., obstacles) which affect radio propagation environment. This information may include, but is not limited to location, material, shape and size of the objects, environment state, e.g. temperature, precipitation, etc.

The current state may be provided to (i.e. made available) and/or obtained at the different radio nodes (e.g., base station nodes) using the DT. How the current state is obtained by the radio node, or the one or more radio nodes, can be implemented in various degrees of distribution. In one case, the current state is first collected by a single node, and then stored in a central database, from which other nodes in turn can collect the information. Alternatively or in addition, the radio node performing the method and/or each of the radio nodes measuring the current state may communicate information sources for the current state, and/or may in addition exchange information between each other in a peer-to-peer manner.

The location (e.g., position) information may be gathered by means of, but not limited to, Internet of Things (IoT, narrowband IoT) sensors with localization capabilities or leveraging positioning algorithms of the radio network itself, e.g. power measurements, time difference of arrival (OTDOA), uplink time difference of arrival (UL-TDOA), round trip time (RTT) and angle-based positioning, etc.

The environmental information and/or DT may be available for other radio nodes than radio node 100. The environmental information and/or DT may be acquired from other radio nodes to the radio node 100. The environmental information and/or DT may be initially collected by a single radio node 100 and stored in a central database (e.g., a shared database and/or a cloud), from which other radio nodes may acquire the environmental information and/or DT. The environmental information may be obtained by more than one radio node 100, optionally in communication with each other. The communication between radio nodes may be peer-to-peer.

In a city environment, the DT may comprise a city transportation system. The DT may be indicative of positions and/or routes of cars, buses, trucks and/or trains (e.g., which can be used as input to the performed RRM). In a factory environment, automated guided vehicles (AGVs) or a control system for AGVs may provide the environmental information, e.g., information about locations and/or paths of the AGVs (e.g., within a factory hall).

The radio node 100 may optionally comprise a predicting module 104. The predicting module 104 may predict the future state of the environment of the radio node 100. The predicting may be understood as anticipating the state of the environment (e.g., state of the at least one physical object within the environment) in future, or in other words predicting the future state. Predicting the future state of the environment of the radio node 100, may be based on the current environment state (e.g., obtained environmental information).

The predicting module 104 may anticipate the at least one physical objects' state (e.g., environment's state) changes over time. For example, the obtaining module 102 may gather environmental information over time and the predicting module 104 may use the obtained environmental information to anticipate (e.g., predict) the future state of the environment.

The obtained environmental information may include a schedule of a trajectory of the one or more physical objects. The future state may be predicted based on the schedule. For example, the one or more physical objects may comprise one or more public transportation vehicles (e.g., a bus, a tram, a trolley or a train). The prediction of the future state may be based on a traffic schedule (e.g., including a street route or railway path with stops and times as the trajectory). Alternatively or in addition, the schedule may be retrieved from a traffic control database. Furthermore, the one or more physical objects may include an automated guided vehicle (AGV). The environmental information may be retrieved (e.g., received) from the AGV.

Predicting the future state may be understood as finding the probability of a future state to actually happen. For example, a future state (e.g., position) of a physical object such as a car, moving with a constant speed on a straight line in the environment most probably would be in a different position proportional to the time passed, rather than same position (e.g., due to suddenly stopping and not moving anymore). Predicting the future state of the environment may comprise a probability related to the future state. The probability may be any number between 0 and 1 (e.g., 0 means the future state is not going to happen and 1 means the future state certainly will happen).

The predicting module 104 may predict future state of the radio node 100 may be based on an artificial intelligence (AI) or a machine learning (ML) algorithm. The machine learning algorithm may use the obtained environmental information for training. The machine learning algorithm may be a supervised or unsupervised or semi-supervised or reinforcement learning or any other types of algorithm. The machine learning algorithm may be trained using the obtained environmental information for the radio node 100. The machine learning algorithm may be trained using the DT of the one or more physical objects in the environment of the radio node 100.

The training phase of machine learning may be done in a dedicated training phase before the radio node 100 (e.g., system) is used for its real purpose, and/or ‘on the fly’ during normal system operation. The training (e.g., updating) may be done periodically or triggered by a change in the environment and/or a change in the DT. The machine learning algorithm may further retrieve the training data from the radio node (e.g., deploy the obtained environmental information of the respective radio node) or a database in communication with the radio node.

The radio node may obtain (e.g., collect) data that is relevant for calculation of the radio channel state (RCS) and may use it in training phase. The obtaining (e.g., collecting) data for training phase may be done through a drive-test campaign, or by synchronization with a corresponding controller (e.g., AGV) which defines routes (e.g., paths) of the moving physical objects.

The obtained environmental information may include a schedule of a trajectory of the one or more physical objects. The future state is predicted based on the schedule. For example, the one or more physical objects may comprise one or more public transportation vehicles (e.g., a bus, a tram, a trolley or a train). The prediction of the future state may be based on a traffic schedule (e.g., including a street route or railway path with stops and times as the trajectory). Alternatively or in addition, the schedule may be retrieved from a traffic control database.

As for another example, the one or more physical objects may include an automated guided vehicle (AGV) and wherein the environmental information is received from the AGV.

The predicting of the future state of the at least one or more physical objects may comprise predicting at least one of a position, a velocity, a trajectory, a size, a shape, an orientation, a rotation, an electromagnetic reflectivity, and an electromagnetic absorption of the respective physical object in the environment of the radio node 100. The RRM may depend on the predicted future state of the at least one or each of the one or more physical objects.

Predicting the future state of the environment may comprise computing the state for a short term and/or using an approximation in first order of time. For example, the position and/or the orientation may be predicted for a time t1 based on the combination obtained for a time t0<t1 assuming a constant velocity and/or rotation, respectively (e.g., by multiplying the velocity and/or rotation, respectively, with the time difference time t1−t0 and adding the obtained velocity and/or rotation). The velocity of a physical object may be constant or changing.

The state of one or more physical objects may be changing periodically (e.g., according to a harmonic motion).

Predicting the future state of the environment may comprise a probability related to the future state. The probability may be any number between 0 and 1 (e.g., 0 means the future state is not going to happen and 1 means the future state certainly will happen).

The current state and/or the future state of the one or more physical objects in the environment of the radio node 100 may be the result of real-time simulations of the one or more physical objects. The real-time simulation of the one or more physical objects may be implemented as one or more digital twins (DTs) of the one or more physical objects in the environment of the radio node 100.

The radio node 100 may take the current and/or future state of the DT, or other external input, into account in the RRM (e.g., for beamforming) performing. The DT may represent physical objects external to the radio node in the coverage area of the radio node (i.e. not just UEs and BSs).

The radio node 100 further comprises a performing module 106 (or RRM module 106) for performing or initiating to perform the RRM. Since the RRM may depend on the state of the environment (e.g., one or more physical objects in the environment of the radio node), the performing or initiating performing the RRM may depend on a future state of the one or more physical objects in the environment of the radio node 100. The future state of the one or more physical objects in the environment of the radio node 100 may be the most probable predicted future state, predicted by the predicting module 104.

Radio resource management (RRM) is the system level management of at least one of co-channel interference, radio resources, and other radio transmission characteristics in wireless communication systems, for example cellular networks, wireless local area networks, wireless sensor systems, and radio broadcasting networks. Alternatively or in addition, the RRM involves strategies and/or algorithms for controlling parameters (e.g., RRM parameters) such as transmit power, user allocation, beamforming, data rates, handover criteria, modulation scheme, error coding scheme, etc. The objective is to utilize the limited radio-frequency spectrum resources and radio network infrastructure as efficiently as possible.

The RRM may be static or dynamic. Alternatively or in addition, the RRM may be an inter-cell RRM.

The RRM requirements (e.g., RRM parameters) guarantee the initial access and mobility performance for the LTE-NR DC, Supplemental Uplink (SUP), and/or NR-NR Carrier Aggregation (CA).

The RRM may depend on the predicted future state (which may eliminate or augment an indirect dependency on an obtained current state). For example, the RRM may explicitly depend on both the obtained current state and the predicted future state. Providing the environmental information (e.g., an environmental state and/or the DT) to the radio node (e.g., network node) may be used to enhance or optimize various RRM functions. The predicting module 104 may predict one or more future state with different probabilities. The position and/or the velocity may be represented by a (e.g., two-dimensional or three-dimensional) vector. The rotation may be a rate of rotation (i.e., a rotational frequency) or an angular velocity of the respective physical object. The orientation and/or the rotation may be represented by an (e.g., two-dimensional or three-dimensional) axial vector.

The performing module 106 may perform or initiate to perform the RRM based on at least one of the obtained environmental information for the radio node 100, the DT of the one or more physical objects in the environment of the radio node 100, and the predicted future state of the environment of the radio node 100.

The predicting of the future state of the physical object, and performing or initiating to perform an RRM may further comprise maintaining for each of the one or more physical objects, the DT of the respective physical object. Obtaining the environmental information may comprise deriving the at least one of future state from the DT of the respective physical object.

The performing module 106 may perform or initiate to perform the RRM based on at least one RRM parameters. The RRM parameters may comprise one or more of
a channel gain,
a signal gain,
a signal to interference and noise ratio (SINR),
a modulation and coding scheme (MCS),
a link adaptation, and
beamforming,

Performing the RRM may comprise computing the one or more RRM parameters based on the future state of one or more DTs representing the one or more physical objects and/or the environmental information.

Alternatively or in addition, performing the RRM may comprise computing the one or more RRM parameters independent of, and/or prior to receiving, reports indicative of channel state information (CSI) received from other radio nodes (e.g., radio devices served by the radio node).

For example, performing the RRM may comprise at least one of:
controlling a power of a radio transmission from the radio node 100;
steering a beam of a radio transmission from the radio node 100 and/or a radio reception at the radio node 100;
handing over a radio device 100-RD to another serving cell;
allocating radio resources in a frequency domain and/or a time domain to a radio device 100-RD; and
adapting a modulation and coding scheme (MCS) of a downlink from the radio node 100 to a radio device 100-RD and/or an uplink from a radio device 100-RD to the radio node 100.

The DT may be maintained for a plurality of physical objects. Performing the RRM may comprise computing beamforming weights for a plurality of radio devices 100-RD. Performing the RRM may further comprise selecting MCSs for a plurality of radio devices 100-RD. The selecting of MCSs may also be referred to as link adaptation.

The impact of the state (e.g., future state) on the RRM parameter may also be directly computed or estimated, i.e. not necessarily by training a machine learning algorithm. For instance, based on the position of a blocker (as an example of one of the one or more physical objects), the computation may comprise determining whether the line-of-sight between a base station (e.g., the network node of the RAN) and a user equipment (e.g., the radio device) with known position is blocked.

If the line-of-sight is not blocked, a certain set of transmission parameters suitable for a good channel is used, e.g. a high modulation coding scheme (MCS), higher order MIMO, low transmit power, and/or a beam directed in the line-of-sight direction. If line-of-sight is blocked, another set of transmission parameters suitable for worse channel is used, e.g. a more robust MCS, higher power, and/or a wider beam covering propagation paths around the blocker.

A more sophisticated example is to combine the state of the RRM parameter with models of the rest of the propagation environment, e.g. a digital map of the environment, and based on this combination calculate the effect on e.g. the channel gain, or directly on signal quality. This calculation may be done e.g. by means of ray-tracing propagation models, where the effect of the blocker (e.g., a physical object in the line of sight between the radio node and the receiver of the radio wave) would be seen in that certain rays are blocked or reflected.

As for an example of the at least one RRM parameter, which can be combined with other RRM parameters, a beamforming parameter is provided. For the case of beamforming, the selection of beams (e.g., transmit weights wₙ) for a set of users n=1 . . . . N depends on the (e.g., future) state (Sₖ) of a set of physical objects (e.g., digital twins) k=1 . . . . K.

$$[ {w}_{1} , … , {w}_{N} ] = {f}_{beam\_forming} ( {S}_{1} , … , {S}_{K} , other parametrs )$$

Herein, f_{beam_forming} may be a function (e.g., in closed form or a tabulated function) and/or based on a machine learning (ML) algorithm. The f_{beam_forming} may be based on the (e.g., predicted) future state of the environment.

As for another example of RRM parameters, which may be combined with other RRM parameters, link adaptation parameter is provided. For the case of link adaptation, or selecting of modulation and coding scheme (MCS), MCS may be based on the (e.g., future) state of the physical objects (e.g., digital twins), e.g., so that:

$$[ {MCS}_{1} , … , {MCS}_{N} = {f}_{link - adaptation} ( {S}_{1} , … , {S}_{K} , other parametrs ) ]$$

Herein, f_{link_adaptation} may be a function (e.g., in closed form such as a mathematical equation or a tabulated function) and/or based on a ML algorithm. The f_{link_adaptation} may be based on the (e.g., predicted) future state of the environment.

Any of the modules of the device 100 may be implemented by units configured to provide the corresponding functionality.

Each of the transmitting station 100 and receiving device may be a radio device (e.g., user equipment) or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR) and vice versa.

FIG. 2 shows an example flowchart for a method 200 of performing radio resource management (RRM), e.g. by the radio node 100 according to FIG. 1.

In a step 202, the radio node 100 may obtain environmental information for the radio node 100. The environmental information may be indicative of a future state of one or more physical objects in an environment of the radio node 100. A propagation of radio waves in the environment may depend on the one or more physical objects.

Optionally, in a step 204, the radio node 100 may predict the future state of the environment of the radio node 100 based on the obtained 202 environmental information.

In step 206, the radio node 100 may perform, or initiate performing, the RRM. The RRM depends on the future state of the one or more physical objects in the environment of the radio node 100.

The method 200 may be performed by the device 100. For example, the modules 102, 104 and 106 may perform the steps 202, 204 and 206, respectively.

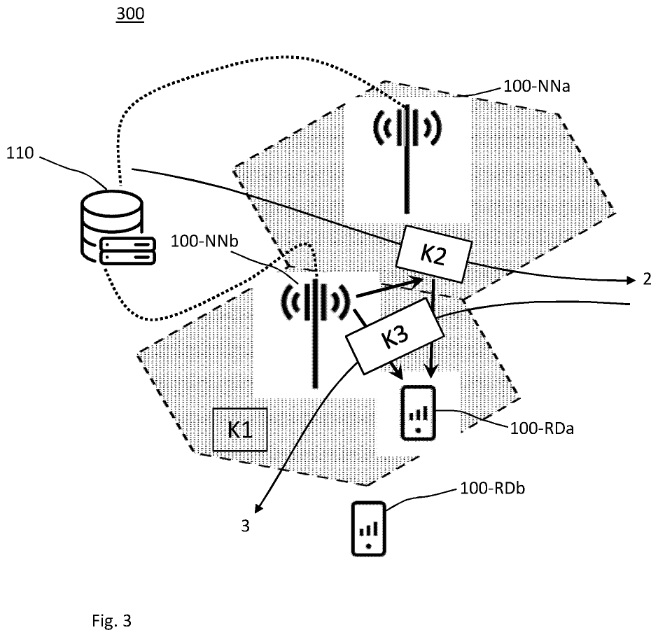

FIG. 3 shows an example of two types or embodiments of the radio node 100 (referred to by 100-NN and 100-RD, respectively) in their environment performing the method of FIG. 2. The one or more radio nodes 100-NN are network nodes (NN) and the one or more radio nodes 100-RD are radio devices (RD). The one or more radio nodes 100-NN may be in radio communication with the one or more radio node 100-RD.

Exemplarily, the environment comprises at least one stationary physical object, e.g. K1, and one or more mobile (e.g., moving) physical objects, e.g. K2 and K3, which may be moving along the arrowed paths 2 and 3, respectively. More specifically, any one of the radio nodes 100-NN and 100-RD may be a physical object or part of a physical object, optionally in the environment of another radio node 100-NN or 100-RD.

Optionally, the radio node 100-RDa acts as a relay radio node for the radio node 100-RDb, which is not in the network coverage of the radio nodes 100-NN. E.g., the relay radio node 100-RDa acts as a network node in a sidelink with the radio node 100-RDb or relays a radio communication between the radio node 100-RDb and the network node 100-NN using a sidelink between the radio node 100-RDa and the radio node 100-RDb.

The radio node 100-NNa may obtain the environmental information comprising the state of the physical object K2 within its environment (e.g., coverage). The state of the physical object K2 may comprise the size, its velocity and the path of the physical object K2. The state of the physical object K2 is indicative of a future state of the physical object K2. The radio node 100-NNa, based on the obtained environmental information, knows at which time and for how long in the future, the physical object K2 may block the line-of-sight between the radio node 100-NNa and the radio node (e.g., radio device) 100-RDa. The radio node 100-NNa may perform the (e.g., best) RRM given the future state of the physical object K2.

The radio node 100-NNa may save the obtained environmental information in local memory of the radio node and/or a database 110 in communication with the radio node 100-NN. The radio node 100-NNb may obtain the environmental information comprising the state of physical objects K1 and K3 within its environment (e.g., coverage). The radio nodes 100-NNb may save the obtained environmental information in a database 110 (e.g., the same the database 110).

The database 110 may be shared between two or more radio nodes, e.g. network nodes 100-NNa and 100-NNb. The radio nodes 100-NNa and 100-NNb may retrieve the other radio node's environmental information from the database 110. In case of a handover procedure (e.g., physical object K3 comprising a radio device and moving from the radio node 100-NNa environment into the radio node 100-NNb environment) having neighbors' environmental information enables the radio node to perform an optimum or preemptive RRM.

As another example, the radio node 100-RDa may retrieve the environment information from the radio node 100-NNb and/or database 110, in case of acting as a relay radio node for radio node 100-RDb. The radio node 100-RDa based on the obtained environmental information knows at which time and for how long in the future, the physical object K3 may block the line-of-sight between the radio node 100-NNb and the radio node (e.g., radio device) 100-RDa, and the line of sight between the radio node 100-NNb and the radio node 100-RDb.

In this example, the physical object K3 may cross (e.g., block) the line-of-sight between radio node 100-NNb and 100-RDa (e.g., as a receiver device) within a certain period of time. The physical object K2 may cross (e.g., block) the line-of-sight between radio node 100-NNa and 100-RDa (e.g., as a receiver device) within a certain period of time.

For instance, the environment may be part of a city. The state of physical object K1 (e.g., a building) may be retrieved from a central database (e.g., a shared database 110) of the city. The state of the physical objects K2 and K3 (e.g., public transport bus or train) comprising their size, path, velocity, and/or schedule may be retrieved from the central database (e.g., the shared database 110) of the city.

The impact of the state (e.g., future state) on the RRM parameter (i.e., the RRM) may be based on a ML algorithm. Alternatively or in addition, the impact of the state (e.g., future state) on the RRM parameter may be directly computed or estimated, i.e. not necessarily by training a model. For instance, performing the RRM may comprise determining, based on the position of a blocker, whether the line-of-sight between a base station and a user with known position is blocked. If the line-of-sight is not blocked, a certain set of transmission parameters suitable for a good channel is used, e.g. a high MCS, higher order MIMO, low transmit power, and/or a beam directed in the line-of-sight direction. If line-of-sight is blocked, another set of transmission parameters suitable for worse channel is used, e.g. a more robust MCS, higher power, and/or a wider beam covering propagation paths around the blocker.

Alternatively or in addition, the obtained environmental information received by one or more radio nodes, e.g., network nodes 100-NNa and 100-NNb, may be used to build a digital twin (DT) of the environment (e.g., physical objects within the environment). The radio nodes 100-NNa and 100-NNb may optionally predict the future state of the physical objects based on the DT of the environment. Furthermore the radio nodes 100-NNa and 100-NNb may perform the RRM based on the DT of the environment. Alternatively or in addition, the DT may be used for training a ML algorithm and/or predicting the future state of the environment using the ML algorithm.

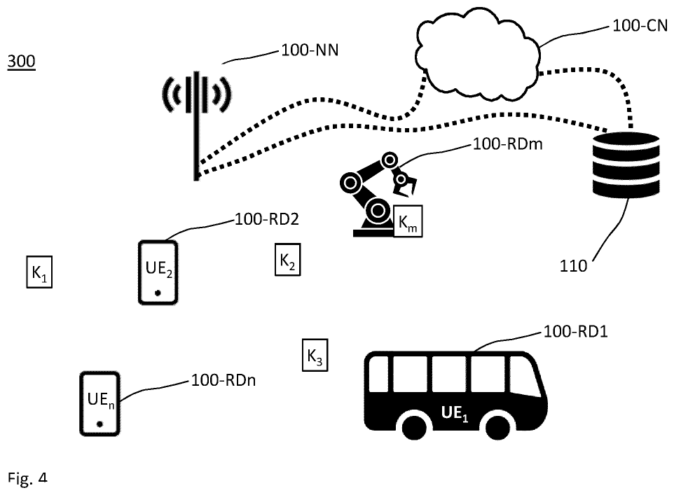

FIG. 4 shows an example of two types of radio node 100-NN and 100-RD in their environment performing the method 200. The radio node 100-NN may obtain the environmental information from the radio devices within the environment of the radio node 100-NN. The radio node, e.g., a network node 100-NN, may be in radio connection with, or may provide radio access to, a plurality of radio devices, e.g. the radio devices 100-RD1, 100-RD2, 100-RDn, and 100-RDm. The environment of the radio node 100-NN may comprise a plurality objects, e.g., the physical objects K1, K2, K3 and Km. As an example, the physical object Km may comprise radio node 100-RDm. The physical object Km may change its size (e.g., state) over time. As another example, the user equipment UE1 may be a physical object comprising a radio node 100-RD1. The physical object UE1, may change its position over time.

The radio node 100-NN (e.g., network node) may be in communication with the database 110. The radio node 100-NN may save the obtained environmental information and/or built DT in the database 110. The radio nodes 100-RD may be in communication directly or indirectly (e.g., via radio node 100-NN) to the database 100.

Alternatively or in addition, the radio node 100-NN may be in communication with a core node 100-CN of a core network (CN) performing the method 200. The core node 100-CN may be in communication with the database 110.

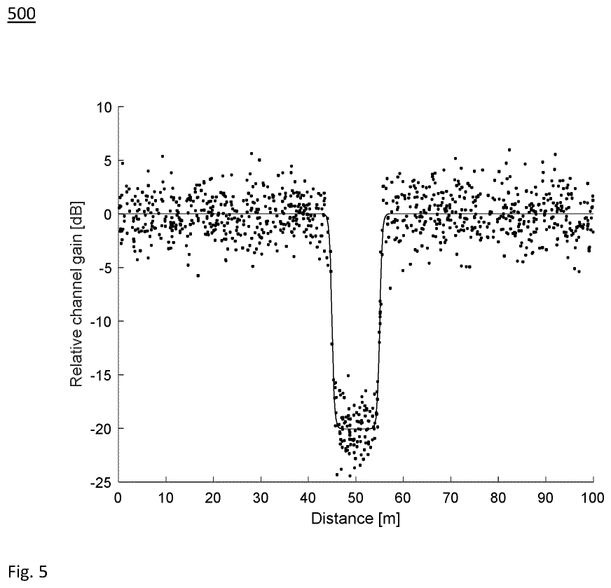

FIG. 5 shows an example of the impact of the state (e.g., future state) on the at least one RRM parameter, e.g., a relative channel gain. The impact may be estimated by creating a (e.g., statistical) model, e.g. by means of regression model.

In this example, the radio node 100 obtained the position xₖ (e.g., as an example of the state) of a set of physical objects (k=1 . . . . K). The radio node 100 may compute how the positions Xx of the K physical objects may affect the channel gain g_{bu} between a set of radio nodes 100 (e.g., base stations) b=1 . . . . B and a set of radio devices (e.g., user equipment) u=1 . . . . U. As an example, the radio node 100 may create a model for the RRM parameter

$${g}_{{bu}_{est}} ( {x}_{1} , … , {x}_{K} ) = {f}_{{0}_{bu}} + {f}_{{1}_{bu}} ( {x}_{1} ) + … + {f}_{{K}_{bu}} ( {x}_{K} ) .$$

The model may comprise a set of functions ƒ_{K}_{_{bu}} (e.g., neural networks). The model may be trained to provide a best fit between a set of observed positions xx and observed gains g_{bu}.

For example, to simulate the impact of a blocker's impact on channel gain, as a function of the blocker's position, the functions ƒ_{K}_{_{bu}}(x_{K}) may be the sum of two parameterized sigmoid functions, e.g. according to

$${f}_{{K}_{bu}} = d ( \frac{- 1}{( 1 + {e}^{( - k ( x - {x}_{1} ) )} )} + \frac{1}{( 1 + {e}^{- k ( x - {x}_{2} )} )} ) .$$

Herein, the parameter d may be the maximum attenuation of the blocker, x₁ and x₂ may represent the positions where the blocker starts and stops impacting the gain (e.g., blocking the line-of-sight between the radio node 100 and a radio receiver or radio transmitter), and k is the slope of the transition between the blocked and non-blocked channel. The positions x₁ and x₂ may further depend on the velocity of the blocker (e.g., physical object).

FIG. 5 shows an example of the above model. In this example, the functions are least-squares-fitted to a number of samples of channel gain at different distances.

The obtained channel gain over time fitted with the above model.

FIG. 5 shows an example of a 1-dimensional blocker (i.e., the position of the blocker is tracked by means of the state in one dimension). The 1-dimensional position of the blocker is referred to as distance in FIG. 5. In general, the position of the blocker may be 2- or 3-dimensional. FIG. 5 shows the decrease of relative channel gain (plotted on a logarithmic scale in dB) when the blocker crosses the line-of-sight between the radio node 100 and the transmitter or receiver in the range between x₁ and x₂ (plotted on a linear scale in m).

After radio node 100 obtains the relationship (e.g., function) between the gain and the position of the blocker, g_{bu_est}(x₁, . . . , x_{K}), it may use that to estimate or modify signal-to-noise and interference (SINR) levels (e.g., as a basis for performing the RRM given the positions Xx of the physical objects). The SINR may directly be used to select appropriate MCSs even for positions xx of the physical objects which were not present in a data set used for training (e.g., fitting) the function. For example, by numerically solving Maxwell's equations, the function between the gain and the position of the blocker (e.g., causing the deduct of 20 dB in gain if the line-of-sight is blocked) may be computed.

The downlink Signal-to-Interference and Noise Ratio (SINR) for a link between an embodiment of the radio node 100 (e.g., a base station) b and a receiver radio device (e.g., user equipment) u may be expressed as

$${SINR}_{bu} = {P}_{tx} \frac{{g}_{bu}}{( {sum}_{i} ( {P}_{tx} {g}_{iu} + {P}_{noise} ) )} ,$$

wherein Pₜₓ is the transmit power of the radio node 100 (e.g., a base station), i is an index to interfering radio nodes (e.g., other base stations), gᵢᵤ is the channel gain between interfering radio node 100 (e.g., base station) i and the receiver radio device (e.g., user equipment) u, and Pₙₒᵢₛₑ is the noise power.

The radio node 100 may estimate the SINR by using the estimated gains:

g_{bu}_{ₑₛₜ}→g_{bu}

gᵢᵤ_{ₑₛₜ}→gᵢᵤ

Then, once SINR_{bu} is estimated, an appropriate MCS for the estimated SINR may be selected.

In one example, the MCS may be selected by maximizing the expected throughput given by

$${MCS}_{bu} = arg {max}_{m} \{ {R}_{m} ( 1 - {BLER}_{m} ( {SINR}_{bu} ) ) \} ,$$

wherein for each MCS, m, Rₘ is the peak data rate of the MCS given no errors, and BLERₘ is the Block Error Rate of the MCS for a given SINR.

The technique may be applied to uplink (UL), downlink (DL) or direct communications between radio devices, e.g., device-to-device (D2D) communications or sidelink (SL) communications.

In any aspect and embodiment, the radio node 100 may use the obtained environmental information indicating a future state of one or more physical objects in the environment of the radio node 100 to perform RRM. For example, the radio node 100 may use one or more digital twins (DTs) of the one or more physical objects in the environment of the radio node 100 and/or other external inputs (e.g., received schedules, etc.) to perform RRM. The one or more DTs may represent the one or more physical objects external to the radio network (e.g. not including, or excluding, UEs and BSs) and/or independent of the radio network (e.g., based on the environmental information other than control signaling of the radio network).

Embodiments using the knowledge of the future state of the physical objects, e.g. using the one or more DTs representing the physical objects, may implement or achieve at least one of the following features and advantages:
RRM may be performed preemptively.
Predictive maintenance of the physical objects may be combined with RRM of the radio node.
The radio access network (RAN) and the physical objects moving therein may be monitored remotely and/or in real-time.
Interference at the physical objects caused by intersecting radio beams can be avoided.
Existing predictive maintenance to maintain the physical objects (e.g. equipment, production lines, and facilities) can be coupled with RRM to improve the performance of the RAN.
Changes of the physical objects within the environment can be anticipated by monitoring them in real-time.
An update of processes using the physical objects does not increase the risk of network outages as the radio node takes the update into account when performing the RRM.
Assumptions as to the impact of the physical objects on the radio propagation in the environment can be tested, validated, and/or refined.
A level of integration between systems comprising the physical objects and a RAN comprising the radio node can be increased.

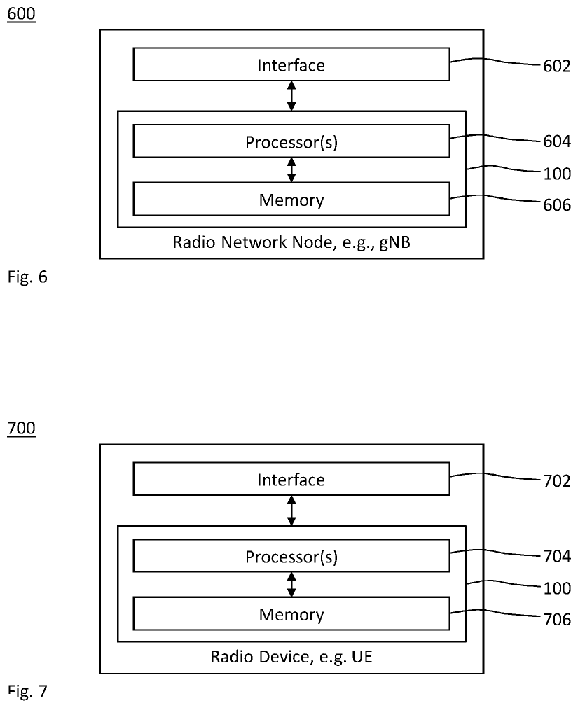

FIG. 6 shows a schematic block diagram for an embodiment of the device 100. The device 100 comprises processing circuitry, e.g., one or more processors 604 for performing the method 200 and memory 606 coupled to the processors 604. For example, the memory 606 may be encoded with instructions that implement at least one of the modules 102, 104 and 106.

The one or more processors 604 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 606, network node functionality. For example, the one or more processors 604 may execute instructions stored in the memory 606. Such functionality may include providing various features and steps discussed herein, including any of the benefits disclosed herein. The expression “the device being operative to perform an action” may denote the device 100 being configured to perform the action.

As schematically illustrated in FIG. 6, the device 100 may be embodied by a (radio) network node 600, e.g., functioning as a base station. The network node 600 comprises a radio interface 602 coupled to the device 100 for radio communication with one or more radio devices, e.g., functioning as a UE.

FIG. 7 shows a schematic block diagram for an embodiment of the device 100. The device 100 comprises processing circuitry, e.g., one or more processors 704 for performing the method 400 and memory 706 coupled to the processors 704. For example, the memory 706 may be encoded with instructions that implement at least one of the modules 102, 104 and 106.

The one or more processors 704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 706, radio device functionality (e.g., as a relay or sidelink transmitter). For example, the one or more processors 704 may execute instructions stored in the memory 706. Such functionality may include providing various features and steps discussed herein, including any of the benefits disclosed herein. The expression “the device being operative to perform an action” may denote the device 100 being configured to perform the action.

As schematically illustrated in FIG. 7, the device 200 may be embodied by a radio device 700, e.g., functioning as a UE. The radio device 700 comprises a radio interface 702 coupled to the device 100 for radio communication with one or more network nodes, e.g., functioning as a base station.

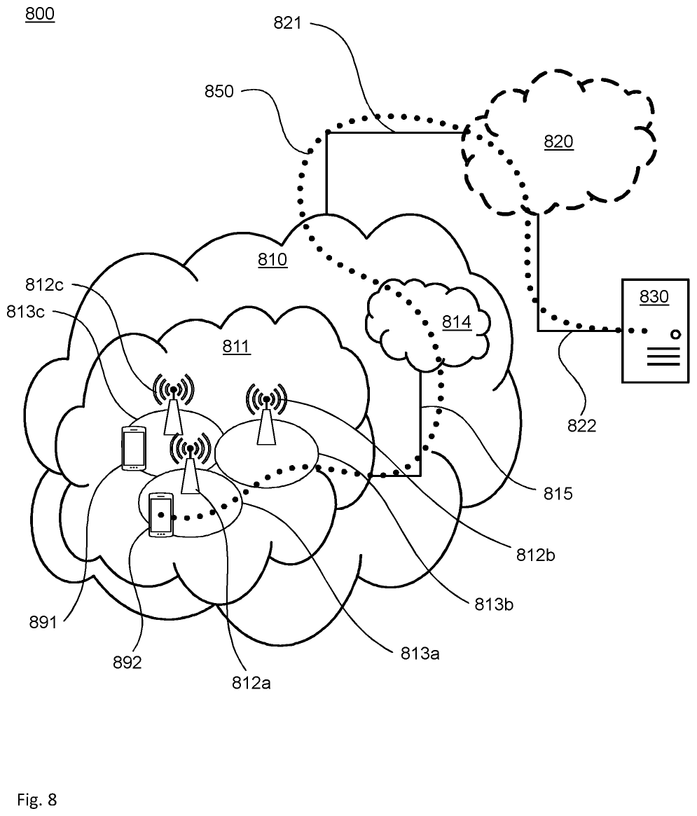

With reference to FIG. 8, in accordance with an embodiment, a communication system 800 includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first user equipment (UE) 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Any of the base stations 812 and the UEs 891, 892 may embody the device 100.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system 800 of FIG. 8 as a whole enables connectivity between one of the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 812 need not be informed about the past routing of an incoming downlink communication with data originating from a host computer 830 to be forwarded (e.g., handed over) to a connected UE 891. Similarly, the base station 812 need not be aware of the future routing of an outgoing uplink communication originating from the UE 891 towards the host computer 830.

By virtue of the method 200 being performed by any one of the UEs 891 or 892 and/or any one of the base stations 812, the performance or range of the OTT connection 850 can be improved, e.g., in terms of increased throughput and/or reduced latency. More specifically, the host computer 830 may indicate to the RAN or the radio node 100 (e.g., on an application layer) a QoS of the traffic or any other trigger for performing the method 200.

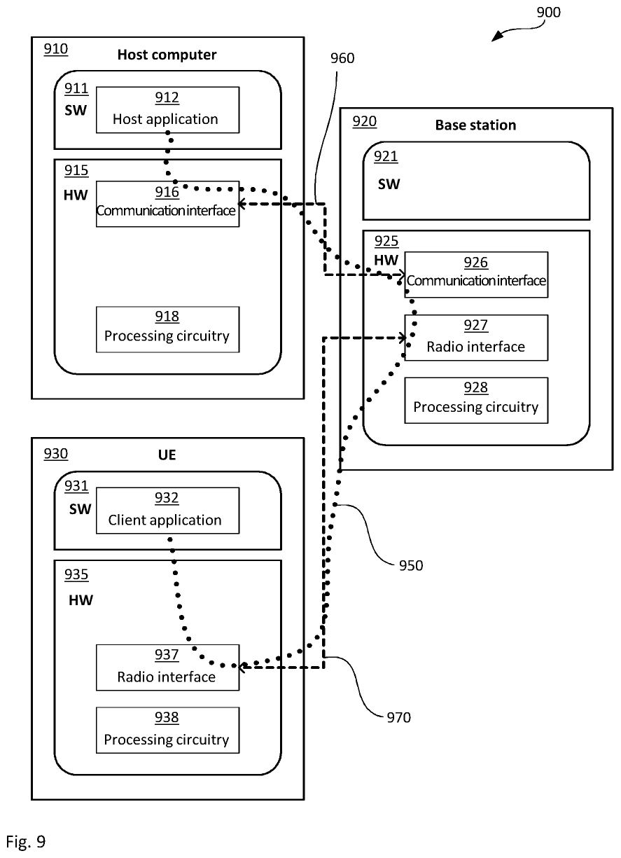

Example implementations, in accordance with an embodiment of the UE, base station and host computer discussed in the preceding paragraphs, will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data, which is transmitted using the OTT connection 950. The user data may depend on the location of the UE 930. The user data may comprise auxiliary information or precision advertisements (also: ads) delivered to the UE 930. The location may be reported by the UE 930 to the host computer, e.g., using the OTT connection 950, and/or by the base station 920, e.g., using a connection 960.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct, or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 812a, 812b, 812c and one of the UEs 891, 892 of FIG. 8, respectively. This is to say, the inner workings of these entities may be as shown in FIG. 9, and, independently, the surrounding network topology may be that of FIG. 8.

In FIG. 9, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or “dummy” messages, using the OTT connection 950 while it monitors propagation times, errors etc.

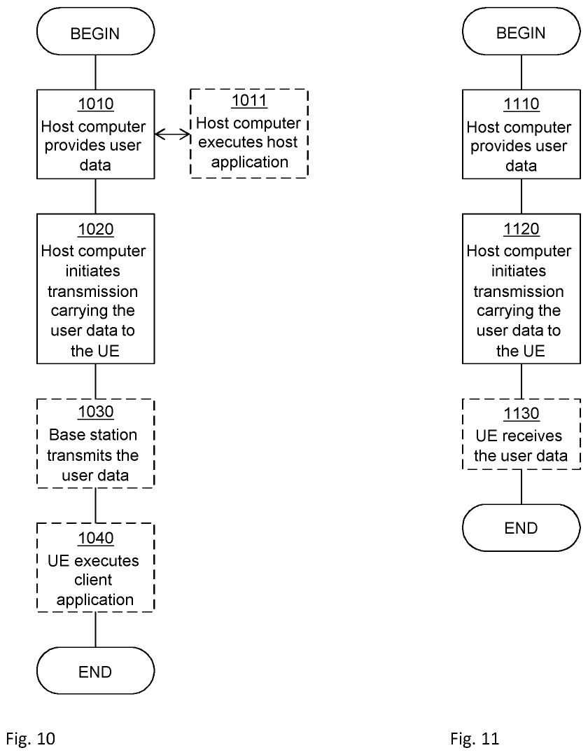

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this paragraph. In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this paragraph. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

As has become apparent from above description, at least some embodiments of the technique allow performing an improved RRM, e.g. by preemptively changing of RRM parameters. Same or further embodiments can ensure an active RRM instead of a reactive RRM (e.g., an outage-avoiding RRM instead of a trouble-shooting RRM). Moreover, same or further embodiments of the radio node 100 may use digital twins (DTs) and/or machine learning (ML) to perform the RRM depending on the environmental information as a large set of input parameters and/or to take more accurate decisions in the RRM.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1.-25. (canceled)

26. A method performed by a radio node for radio resource management (RRM) in a radio access network (RAN), the method comprising:
obtaining environmental information for the radio node, wherein the environmental information is indicative of a future state of one or more physical objects in an environment of the radio node, wherein propagation of radio waves in the environment depends on the one or more physical objects; and
performing, or initiating performance of, RRM based on the future state of the one or more physical objects in the environment of the radio node.

27. The method of claim 26, wherein the environmental information is indicative of a current state of the one or more physical objects in the environment of the radio node, and the current state is indicative of the future state of the one or more physical objects in the environment of the radio node.

28. The method of claim 27, wherein the environmental information is obtained based on or more of the following:
measuring the current state of at least one of the one or more physical objects, and
receiving measurements of the current state of at least one of the one or more physical objects from one or more other radio nodes.

29. The method of claim 28, wherein:
the radio node and the one or more other radio nodes are network nodes of the RAN; and
the one or more physical objects include respective radio devices served by the radio node or by one of the other radio nodes.

30. The method of claim 28, wherein:
the radio node is a radio device wirelessly connected to a network node of the RAN;
the one or more other radio nodes are other radio devices wirelessly connected to at least one of the following: the network node of the RAN, and the radio node;
the one or more physical objects include the one or more other radio nodes.

31. The method of claim 26, wherein:
the radio node is a core node wirelessly connected to at least one network node of the RAN;
the environmental information of the core node is obtained from at least one of the following: the at least one network node, and radio devices served by the at least one network node; and
the one or more physical objects include respective radio devices served by the core node.

32. The method of claim 26, wherein:
the environmental information is external to at least one the RAN and a core network (CN) coupled to the RAN;
at least one of the one or more physical objects is not a radio device served by a RAN or the CN;
the environmental information is obtained based on one or more of the following:
receiving reports of the environmental information from radio devices served by the radio node; and
retrieving the environmental information from a database used for scheduling or controlling the motion of the one or more physical objects.

33. The method of claim 26, wherein for each of the one or more physical objects, the future state of the physical object in the environment of the radio node includes one or more of the following: position, velocity, trajectory, size, shape, orientation, rotation, electromagnetic reflectivity, and electromagnetic absorption.

34. The method of claim 26, further comprising predicting the future state of the one or more physical objects in the environment of the radio node based on the obtained environmental information, wherein the RRM is based on the predicted future state of the at least one of the one or more physical objects.

35. The method of claim 34, wherein one or more of the following applies:
the one or more physical objects include an automated guided vehicle (AGV) and the environmental information is obtained from the AGV; and
the obtained environmental information includes a schedule of a trajectory of the one or more physical objects, and the future state of the one or more physical objects is predicted based on the schedule.

36. The method of claim 34, wherein:
predicting the future state of the one or more physical objects is performed by a machine learning entity; and
the machine learning entity is trained based on one or more of the following:
the obtained environmental information for the radio node, and
a digital twin (DT) of the one or more physical objects in the environment of the radio node.

37. The method of claim 34, wherein predicting the future state of the one or more physical objects comprises, for each of the one or more physical objects, maintaining a digital twin (DT) representing the physical object and deriving the future state of the physical object from the DT representing the physical object.

38. The method of claim 26, wherein the RRM is performed or initiated further based on at least one of the following:
the obtained environmental information for the radio node;
a digital twin (DT) representing the one or more physical objects in the environment of the radio node; and
a predicted future state of the environment of the radio node, the predicted future state being predicted based on the obtained environmental information.

39. The method of claim 26, wherein:
the future state is a future state of a digital twin (DT) representing the one or more physical objects;
the method further comprises computing one or more of the following RRM parameters based on the future state of the DT and/or the environmental information: channel gain, signal gain, signal to noise and interference ratio (SINR), modulation and coding scheme (MCS), a link adaptation parameter, and a beamforming parameter; and
the RRM is performed or initiated based on the computed one or more RRM parameters.

40. The method of claim 26, wherein performing, or initiating performance of, RRM based on the future state of the one or more physical objects in the environment of the radio node comprises one or more of the following:
controlling a power of a radio transmission from the radio node;
steering a beam of a radio transmission from the radio node and/or a radio reception at the radio node;
handing over a radio device to another serving cell;
allocating radio resources in a frequency domain and/or a time domain to a radio device;
adapting modulation and coding scheme (MCS) of at least one of a downlink and an uplink between the radio node and a radio device;
selecting respective MCS for a plurality of radio devices served by the radio node; and
computing beamforming weights for a plurality of radio devices served by the radio node.

41. A radio node configured for radio resource management (RRM) in a radio access network (RAN), the radio node comprising:
memory operable to store executable instructions; and
processing circuitry operable to execute instructions stored in the memory, wherein execution of the instructions causes the radio node to:
obtain environmental information for the radio node, wherein the environmental information is indicative of a future state of one or more physical objects in an environment of the radio node, wherein propagation of radio waves in the environment depends on the one or more physical objects; and
perform, or initiate performance of, RRM based on the future state of the one or more physical objects in the environment of the radio node.

42. The radio node of claim 41, wherein for each of the one or more physical objects, the future state of the physical object in the environment of the radio node includes one or more of the following: position, velocity, trajectory, size, shape, orientation, rotation, electromagnetic reflectivity, and electromagnetic absorption.

43. The radio node of claim 41, wherein execution of the instructions further causes the radio node to predict the future state of the one or more physical objects in the environment of the radio node based on the obtained environmental information, wherein the RRM is based on the predicted future state of the at least one of the one or more physical objects.

44. The radio node of claim 43, wherein one or more of the following applies:
the one or more physical objects include an automated guided vehicle (AGV) and the environmental information is obtained from the AGV; and
the obtained environmental information includes a schedule of a trajectory of the one or more physical objects, and the future state of the one or more physical objects is predicted based on the schedule.

45. The radio node of claim 41, wherein execution of the instructions further causes the radio node to perform, or initiate performance of, RRM based on the future state of the one or more physical objects in the environment of the radio node based on one or more of the following:
controlling a power of a radio transmission from the radio node;
steering a beam of a radio transmission from the radio node and/or a radio reception at the radio node;
handing over a radio device to another serving cell;
allocating radio resources in a frequency domain and/or a time domain to a radio device;
adapting modulation and coding scheme (MCS) of at least one of a downlink and an uplink between the radio node and a radio device;
selecting respective MCS for a plurality of radio devices served by the radio node; and
computing beamforming weights for a plurality of radio devices served by the radio node.
